(19) United States
(12) Patent Application Publication
(10) Pub. No.: US 2006/0127589 A1
(43) Pub. Date: Jun. 15, 2006

(54) Device and process for the production of films or compound moldings

(75) Inventors: Ingo Kleba, Konigswinter (DE); Jurgen Wirth, Koln (DE); Frank Berghahn, Konigswinter (DE)

Correspondence Address: BAYER MATERIAL SCIENCE LLC, 100 BAYER ROAD, PITTSBURGH, PA, 15205, US

(73) Assignee: Hennecke GmbH

(21) Appl. No.: 11/295,266

(22) Filed: Dec. 6, 2005

(30) Foreign Application Priority Data
Dec. 9, 2004 (DE) 102004059218.7

(51) Int. Cl. B05D 1/02; B05D 5/00; B29B 15/10

(52) U.S. Cl. 427/421.1; 427/427.3; 118/302

(57) ABSTRACT

A device and process for the production of single- or multi-layered films or compound moldings which have at least one layer of reactive plastic. The liquid reactive mixture is sprayed from a spray nozzle on to a surface. The jet spray is set in oscillation and the amplitude and/or frequency of the oscillation is adjusted during the spraying operation. Adjustment of the oscillation changes the spray area.

### BACKGROUND OF THE INVENTION

The present invention relates to a process and to a device for the production of films (skins) or compound moldings.

In the production of single- or multi-layered films (skins) or compound moldings in which at least one layer comprises a reactive plastic, this reactive plastic layer is applied by spraying into a cavity or on to a substrate.

FIGS. 1 and 2 show by way of example the prior art method for production of compound moldings. A first layer of reactive plastic is initially applied into the cavity of the mold lower part through the spray mixing head. A substrate is then laid on this first spray layer by means of the automatic feeder, and a further layer of reactive plastic is sprayed on to the substrate. The lower and the upper mold halves are then brought together and the reactive plastic mixture reacts and intimately bonds with the substrate. After “curing”, the press is opened again and the finished compound molding can be removed.

In one variation of this process, the substrate is sprayed on both sides outside the cavity and then laid in the mold.

Since the travelling speeds of the automatic applicators, i.e. the speed of the spray nozzle which can be achieved relative to the surface to be coated, encounters limits, attempts have been made to generate spray jets with the widest possible spray pattern. Various techniques have been tried in this context. One of these techniques uses a flat jet nozzle, which already has a somewhat broader spray pattern, and increases the distance between the spray nozzle and the surface to be sprayed. However, this technique leads to a poor material distribution, namely the so-called “bone profile”, i.e. to accumulations of material at the edges of the spray jet. A further disadvantage is the generation of so-called “overspray”, i.e. fine spray mist which disperses in the entire production room and therefore must be sucked out in order to protect personnel from damage to health. Apart from the increased outlay on installations, sucking out of the overspray also means a loss of material and additional maintenance times for the suction and filter installations.

In another method, the spray jet is generated with a circular jet nozzle and then reshaped to make the spray jet flat by means of air nozzles directed on it from the side. However, this also generates a non-uniform distribution of material. In this case, the so-called “lens profile”, an accumulation of material in the middle of the spray jet, results. Here also, the generation of overspray in particular due to the addition of air is a serious deficiency.

With circular jet nozzles it is also possible to increase the distance between the spray nozzle and the area to be sprayed and to admix air internally to the reactive mixture. This results in a broader “spray pattern”, although with a very poor distribution of material, since a “thinning at the edge” takes place. That is to say, there is too little material at the edges of the layer sprayed on. Here also harmful overspray is generated.

All of these methods described above have a further serious disadvantage: “edge sharpness” is lost, i.e., no exact contour can be sprayed at the edges of the cavity, so the sealing faces are sprayed beyond the edge.

In addition to the requirement of minimized cycle times, there is the further object of being able to establish the distribution of material in the spray layers, i.e. the spray layer thickness per unit area, as desired. This can mean generating the same layer thickness over the entire area to be sprayed or also thicker layer thicknesses at predetermined points of the moulding or spray skin.

To meet this further requirement, it is necessary, apart from varying the spray quantity and/or the travelling speed of the spray mixing head, also to be able to adjust the spray jet width during the spraying operation.

In the past, attempts have been made to achieve this object with the measures already described: varying the addition of air or varying the spray distance. However, these in turn resulted in the same deficiencies already described: non-uniform distribution of material, generation of overspray and blurred edge sharpness.

### SUMMARY OF THE INVENTION

The object of the present invention is therefore to discover a simple and economical process and a device for the production of large-area, complex compound moldings or films (skins) for large series production in which the disadvantages described above are avoided.

This object is achieved by oscillating the jet spray during spraying and adjusting the amplitude and/or frequency of oscillation during spraying.

### BRIEF DESCRIPTION OF THE DRAWINGS

FIG. 1 illustrates a device for the production of compound moldings in accordance with the prior art process in which a substrate is laid in the lower mold half on to a first spray layer.

FIG. 2 illustrates the same device as that shown in FIG. 1 in which a second layer is applied to the substrate.

FIG. 3 illustrates diagrammatically oscillating spray jets in two different positions. The width A₁ of the sprayjet is adjusted from a first position to the width A₂ in a second position.

FIG. 4 illustrates a section through the molding shown in FIG. 5.

FIG. 5 illustrates a molding which has been produced in a cavity by the process of the present invention.

### DETAILED DESCRIPTION OF THE INVENTION

The present invention relates to a process for the production of single- or multi-layered films or compound moldings which have at least one layer of reactive plastic, in which the liquid reactive mixture is sprayed from a spray nozzle with a sprayjet on to a surface. The spray jet is set in oscillation and the amplitude and/or frequency of the oscillation is adjusted during the spraying operation and the spray area is thereby changed.

The surface to be sprayed can be a substrate to be coated or a part of the mold, for example the lower mold or tool half. Polyurethane is preferably used as the reactive plastic.

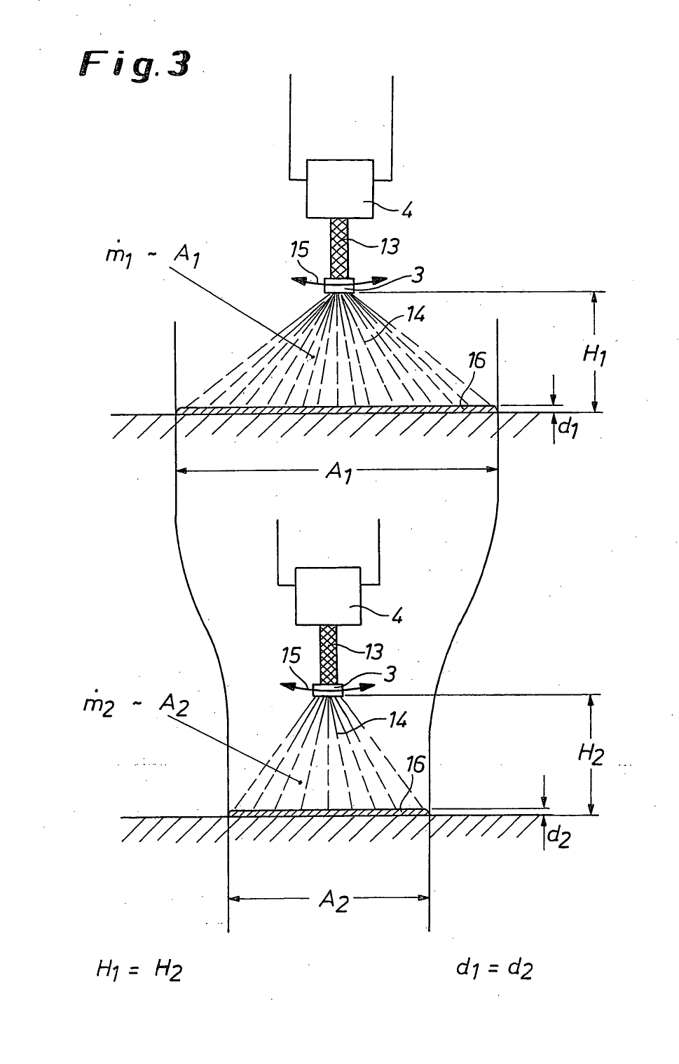

FIGS. 3, 4 and 5 illustrate the present invention. They show a process in which the spray jet is set in oscillations during the spray application and the spray width or spray area is changed during the spray application by adjusting the amplitude and/or frequency of the oscillation.

DE-OS-35 30 702 describes a spray device having a downstream perforated rose which is said to eliminate very fine scattered aerosols, it being possible for this perforated rose to be set in vibration, which improves the uniformity of the foam layer sprayed on.

However, this device does not provide a change in the vibration, that is to say the amplitude and/or frequency of the oscillation during the spraying operation. In particular, DE-OS-35 30 702 does not disclose that different spray widths can be established with this measure.

The process of setting the spray jet in oscillations and of varying the spray jet width or spray area during the spray application by adjusting the amplitude and/or the frequency of the oscillation is not disclosed in the prior art.

The process according to the invention provides the decisive advantage of being able to establish different spray jet widths without having to change the spray distance. The important production parameter of spray distance therefore remains free for other production requirements which result, e.g., from geometric constraints in the three-dimensional space. An additional degree of freedom is thereby obtained for the spray process.

In the process according to the invention, manipulation of the spray jet with addition of air is unnecessary. The overspray content in the spray process is therefore extremely minimal.

Maximum spray widths of up to 1,000 mm are possible with the process according to the invention. In general, the spray jet impinges on the spray area oscillating with an adjustable amplitude of >0 mm to 500 mm, preferably 0.1 to 400 mm, most preferably an adjustable amplitude of 0.5 to 300 mm.

The frequency of the oscillation can be established in the range from 5 to 400 Hz, preferably 10 to 300 Hz, most preferably 20 to 200 Hz.

The frequency required for the process according to the invention depends on (1) the travelling speed of the automatic applicator, which moves the mixing head and the spray nozzle and therefore also the sprayjet, and (2) the width of the spray jet impinging on the spray area at right angles to the plane of oscillation of the spray mixing head. In this context, the frequency is preferably chosen so that no areas which are not wetted by the spray jet remain between the turning points of the oscillations. The oscillation frequency required is therefore proportional to the travelling speed of the automatic applicator and inversely proportional to the spray jet width at right angles to the plane of oscillation.

The change in the amplitude and/or frequency of the oscillation during the spray application can take place constantly or also in a ramp function.

In a further embodiment of the process according to the invention, the amount of reactive mixture discharged can also be varied during the change in spray jet width or area. This provides the possibility of being able to establish the thickness of the spray layer as desired.

It is also possible to vary the travelling speed of the automatic applicator during the change in spray jet width or area. For example, lowering of the travelling speed compared with the maximum speed may be necessary in narrow curves.

In a further embodiment of the process according to the invention, the particular adjustments are made according to position, and in particular automatically by a program control.

There are various possibilities for setting the spray jet in oscillation. Thus, e.g., the entire spray mixing head or only the spray nozzle alone or only the spray nozzle with its connection to the mixing head can be caused to oscillate.

Oscillating deflecting elements subordinate to the spray nozzle are also possible.

Both circular spray nozzles and flat spray nozzles are suitable as the spray nozzles.

In a further embodiment of this new process, the oscillation can be superimposed by a second oscillation displaced by an angle of >0°, preferably by an angle of 40° to 90°, more preferably by an angle of 700 to 90°, most preferably by an angle of 90°, the amplitudes of the two oscillations being controlled independently of one another.

It is furthermore possible for the larger amplitude of the two oscillations to be established at right angles to the travelling direction of the automatic applicator automatically by a control program.

The process variant of having two planes of oscillation displaced by an angle with respect to one another is of particular interest for the process described because it renders possible extremely minimized spray application times. In this context, the angle is preferably 40 to 90°, since in this case there are no longer any down times of the automatic applicator during the spray application because rotation of the mixing head at the turning points of the spray track to be travelled are then no longer necessary.

The invention also relates to a device for the production of single- or multi-layered films or compound moldings which includes at least one layer of reactive plastic, comprising reservoir containers for the reactive components, metering devices for the reactive components and a mixing head and a spray nozzle, in which the spray nozzle is connected to an oscillation generator which can set the spray nozzle in oscillation, the oscillation generator being adjustable in amplitude and/or frequency of the oscillation.

Electromagnets, for example, can be employed as the oscillation generator. The amplitude is adjustable in this case by varying the voltage. Mechanical gears with an eccentric displacement are also suitable for generation of oscillations.

In this context, the spray nozzle can be connected to the oscillation generator directly or via apparatus components arranged in between.

In one embodiment of the device, an elastic member or a ball joint or bellows are arranged between the mixing head and spray nozzle.

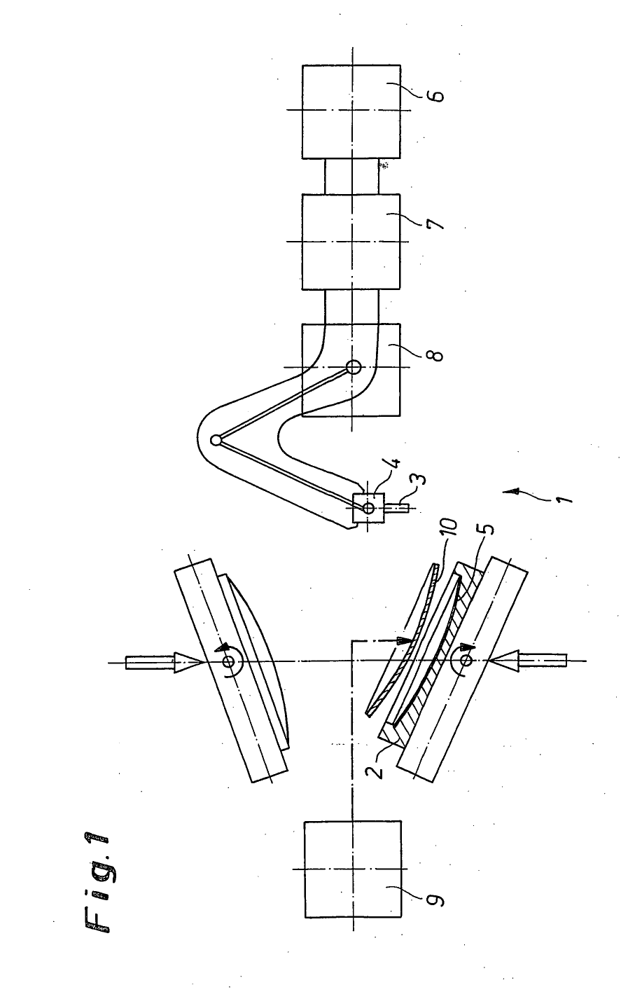

The invention is explained in more detail below with reference to FIGS. 1-5.

FIG. 1 shows a device 1 for the production of compound moldings according to the prior art. A first layer of reactive mixture is initially applied to the surface of the cavity of the lower mold half 2 by the spray nozzle 3, which is arranged directly after the mixing head 4.

The reactive components arrive via assigned lines from the raw material reservoirs 6 at the metering installation 7. From the metering installation 7 in turn, they are conveyed by means of further assigned lines via the automatic unit 8 for the mixing head guide to the mixing head 4, are mixed with one another there and are subsequently applied by spraying as a reactive mixture through the spray nozzle 3.

In this operation, the mixing head 4 with the spray nozzle 3 is guided by the automatic unit 8 in a manner such that an equally thick spray layer is formed on the entire surface of the cavity. Thereafter, the spray operation is ended and the mixing head 4 with the spray nozzle 3 is swivelled to the side by the automatic unit 8.

A substrate 10 is then laid on this first spray layer 5 by means of the automatic feeder 9.

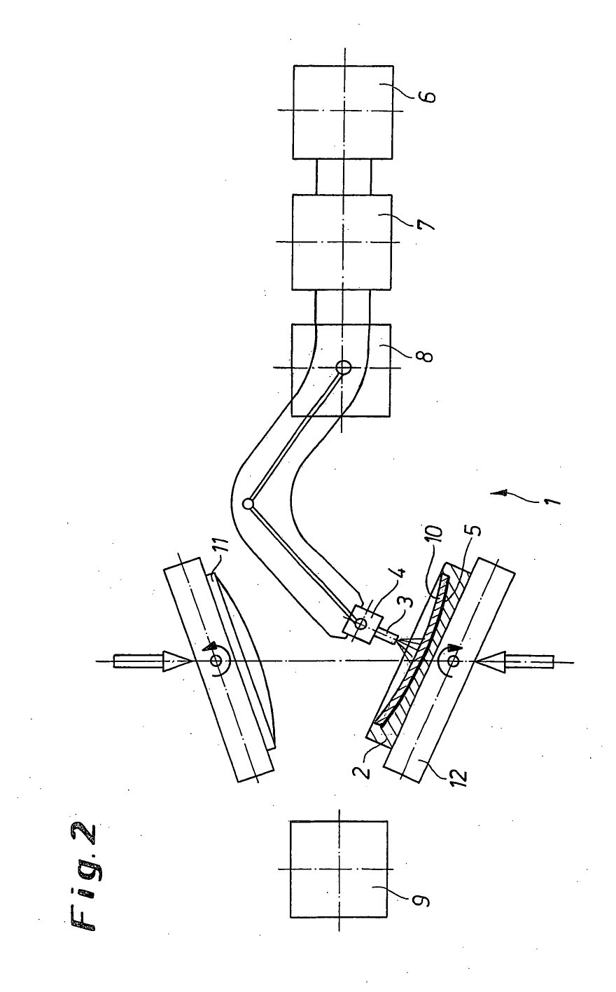

FIG. 2 shows the same device as FIG. 1 at a different point in the process, i.e., during application of a second spray layer on to the substrate 10. When this operation has ended, the mixing head 4 with the spray nozzle 3 is in turn swivelled to the side by the automatic unit 8 and the lower mold half 2 and the upper mold half 11 are brought together by the press 12 and the actual reaction process of the plastic can start so that the still liquid reactive plastic mixture reacts and undergoes intimate bonding with the substrate 10.

After the so-called curing, the press 12 opens again and the finished molding can be removed.

FIGS. 3, 4 and 5 illustrate the process according to the invention. FIG. 3 shows the mixing head 4 with the spray nozzle 3 in diagram form in a first position (which is shown in the upper part of FIG. 3 and referred to as FIG. 3a) and in a second position (which is shown in the under part of FIG. 3 and referred to as FIG. 3b). An elastic member 13 is arranged between the mixing head 4 and spray nozzle 3. The spray nozzle and therefore the spray jets 14 are set in oscillations by an oscillation generator (not shown). The oscillations are indicated in diagram form by the double arrows 15.

The spray distances H₁ and H₂ between the spray nozzle 3 and the surface 16 to be sprayed are the same in both FIGS. 3a and 3b. In the first position (FIG. 3a), the spray jet 14 impinging on the surface 16 to be sprayed has the width A₁, and in the second position (FIG. 3b) the spray jet 14 impinging on the surface 16 to be sprayed has the width A₂.

The transition from the spray width A₁ in the first position (FIG. 3a) to the spray width A₂ in the second position (FIG. 3b) is caused, for example, by a constant reduction in the amplitude of the oscillation of the spray jet. So that the spray layer thicknesses d₁ and d₂ are of equal thickness everywhere, the stream of material is also changed proportionally at the same time. The stream of material m₁ of reactive mixture in the first position (FIG. 3a) is proportional to the spray width A₁, and the stream of material m₂ is proportional to the spray width A₂.

An alternative to adaptation of the streams of material is adaptation of the travelling speeds of the spray nozzle 3 and the mixing head 4 via the automatic unit 8, and in particular inversely proportionally to the spray widths.

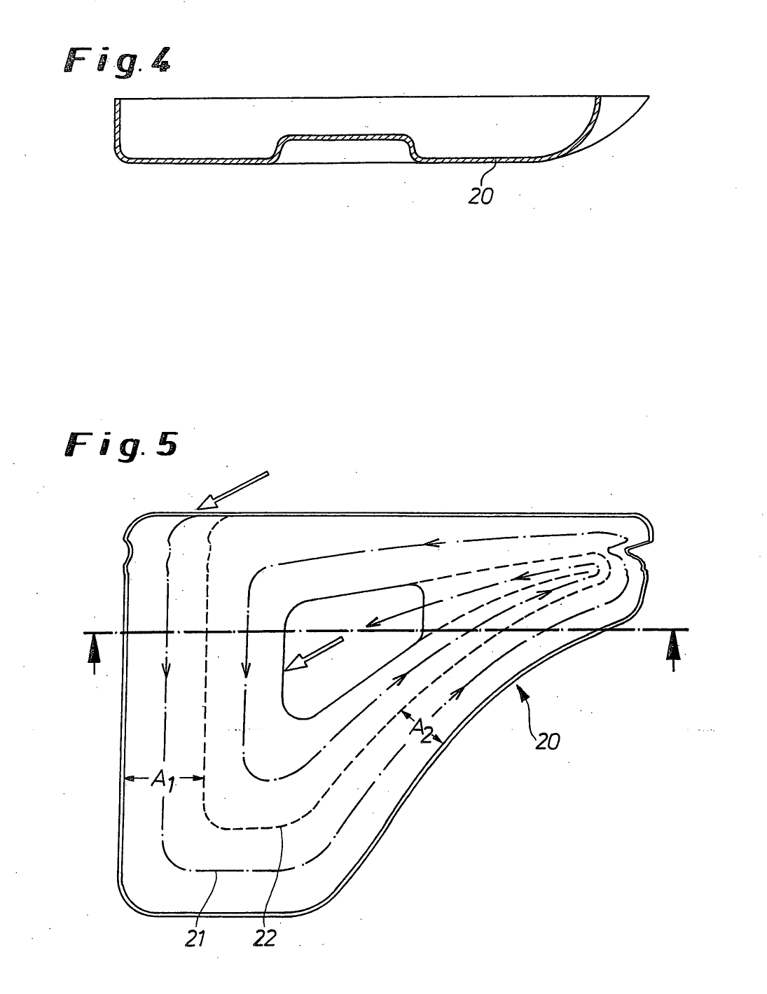

FIG. 4 shows a section through the molding 20 shown in FIG. 5, namely a skin produced in a cavity (not shown) from a reactive plastic and having a layer thickness of the same thickness over the entire area.

FIG. 5 shows the same molding 20, namely a skin or film of a reactive plastic which is produced by the process according to the invention. The entire spraying operation takes place to cover the area fully in only one pass. So that the layer thickness is about the same everywhere over the entire area, a defined, narrow overlapping of adjacent spray tracks is essential. For this reason, the spray jet width and proportionally to this also the amount of reactive mixture discharged is adapted constantly by a programmable control according to the molding geometry. At the first position (FIG. 3a) the spray track has the width A₁, and at the second position (FIG. 3b), the spray track has the width A₂.

The dash-dot line 21 shows the travelling route over the cavity (not shown) of the mixing head and spray nozzle (also not shown) guided over this. The broken line 22 shows the line where the reactive mixture from adjacent spray regions, which is still liquid during the spray application, merges.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of single- or multi-layered films or compound moldings which have at least one layer produced with a reactive plastic, comprising spraying a liquid reactive mixture onto a surface from a spray nozzle in a manner such that an oscillating jet spray is applied to the surface and amplitude and/or frequency of the oscillation of the jet spray is adjusted during spraying to change surface area covered by the jet spray.

2. The process of claim 1 in which the oscillating jet spray oscillates with an amplitude of >0 mm to 500 mm.

3. The process of claim 1 in which the oscillating jet spray oscillates with an amplitude of from 0.1 mm to 400 mm.

4. The process of claim 1 in which the oscillating jet spray oscillates with an amplitude of from 0.5 to 300 mm.

5. The process of claim 1 in which the jet spray oscillates with a frequency of 5 Hz to 400 Hz.

6. The process of claim 1 in which the jet spray oscillates with a frequency of 10 Hz to 300 Hz.

7. The process of claim 1 in which the jet spray oscillates with a frequency of 20 Hz to 200 Hz.

8. The process of claim 1 in which the amplitude and/or frequency are adjusted on a continuous basis.

9. The process of claim 1 in which the amplitude and/or frequency are adjusted in accordance with a ramp function.

10. The process of claim 1 in which the distance between the spray nozzle and the surface to be sprayed is kept constant during adjustment of the amplitude and/or frequency of the jet spray.

11. The process of claim 1 in which amount of reactive mixture sprayed is changed during adjustment of the amplitude and/or frequency of the jet spray.

12. The process of claim 1 in which speed of the spray nozzle relative to the surface area to be sprayed is changed during adjustment of the amplitude and/or frequency of the oscillating jet spray.

13. The process of claim 1 in which adjustment of the amplitude and/or frequency of the oscillating jet spray is made according to position automatically by a control program.

14. The process of claim 1 in which the spray nozzle and a mixing head associated with that spray nozzle are set in oscillation.

15. The process of claim 1 in which only the spray nozzle or the spray nozzle with its connection to a mixing head is set in oscillation.

16. The process of claim 1 in which the oscillation is superimposed by a second oscillation displaced by an angle of >0°.

17. The process of claim 16 in which the amplitudes of the oscillations displaced by 90° are controlled independently of one another.

18. The process claim 16 in which the larger amplitude of the two oscillations is established at right angles to the travelling direction of the spray nozzle automatically by a control program.

19. A device for the production of single- or multi-layer films or compound moldings composed of at least one layer of reactive plastic, comprising
a) at least one reservoir container for reactive components,
b) at least one metering device for reactive components
c) a mixing head,
d) a spray nozzle, and
e) means for causing the spray nozzle to oscillate which means is capable of being adjusted in amplitude and/or frequency.

20. The device of claim 19 which further comprises (f) an elastic member arranged between the mixing head and spray nozzle.

21. The device of claim 19 which further comprises a ball joint arranged between the mixing head and spray nozzle.

22. The device of claim 19 which further comprises bellows arranged between the mixing head and spray nozzle.
